(19) United States
(12) Patent Application Publication
(10) Pub. No.: US 2026/0153730 A1
(43) Pub. Date: Jun. 4, 2026

(54) WEDGED WINDOW FOR MULTI-MODE SYSTEM

(71) Applicant: Raytheon Company, Tewksbury, MA (US)

(72) Inventors: Alexandre J. St Peter, Marana, AZ (US); Ronald L. Roncone, Tucson, AZ (US)

(21) Appl. No.: 18/967,385

(22) Filed: Dec. 3, 2024

(51) Int. Cl. G02B 27/00; G02B 23/16

(52) U.S. Cl. CPC G02B 27/0025; G02B 23/16

(57) ABSTRACT

A wedged window for a multi-mode system includes an outer curved surface and an inner curved surface. The inner curved surface is tilted at a specified angle with respect to the outer curved surface. The outer curved surface is configured to receive a signal wavefront for a multi-mode optical device that includes the multi-mode system and an off-axis optical system. The inner curved surface is configured to direct a refracted wavefront based on the signal wavefront toward the off-axis optical system.

### TECHNICAL FIELD

This disclosure relates generally to optical devices and systems. More specifically, this disclosure relates to a wedged window for a multi-mode system.

### BACKGROUND

Conventional optical devices that include multiple optical systems receiving image information through a single dome may include optical systems that are aligned off-axis. In addition, due to space constraints, multi-mode systems that include two or more optical systems may position each optical system off-axis. Any optical system that is aligned off-axis in such a device receives image information through an oblique section of the dome, which can introduce severe aberrations into images formed by the optical system.

### SUMMARY

This disclosure relates to a wedged window for a multi-mode system.

In a first embodiment, a wedged window for a multi-mode system may include an outer curved surface and an inner curved surface. The inner curved surface may be tilted at a specified angle with respect to the outer curved surface. The outer curved surface may be configured to receive a signal wavefront for a multi-mode optical device that includes the multi-mode system and an off-axis optical system. The inner curved surface may be configured to direct a refracted wavefront based on the signal wavefront toward the off-axis optical system.

Any single one or any combination of the following features may be used with the first embodiment. The outer curved surface may be substantially aligned with an optical axis of the off-axis optical system. The specified angle may be determined based on a distance between an optical axis of the off-axis optical system and a dome optical axis of the multi-mode system. The wedged window may include a specified material, and the specified angle may be determined based on the specified material. The off-axis optical system may include at least one specified material, and the specified angle may be determined based on the at least one specified material. The off-axis optical system may include a specified type of optical system, and the specified angle may be determined based on the specified type of optical system. The off-axis optical system may include a long-wave infrared (LWIR) telescope, a mid-wave infrared (MWIR) telescope, a short-wave infrared (SWIR) telescope, an ultraviolet (UV) telescope, or a visible light telescope. The wedged window may include sapphire, zinc sulfide, zinc selenide, germanium, silicon, calcium fluoride, chalcogenide glasses, nanocrystalline optical ceramics, germanate glass, or calcium aluminate glass.

In a second embodiment, a multi-mode system may include a dome frame and a wedged window coupled to the dome frame. The wedged window may include an outer curved surface and an inner curved surface. The inner curved surface may be tilted at a specified angle with respect to the outer curved surface. The outer curved surface may be configured to receive a signal wavefront for a multi-mode optical device that includes the multi-mode system and an off-axis optical system. The inner curved surface may be configured to direct a refracted wavefront based on the signal wavefront toward the off-axis optical system.

Any single one or any combination of the following features may be used with the second embodiment. The wedged window may include a specified material, the off-axis optical system may include at least one specified material, and the off-axis optical system may include a specified type of optical system. The specified angle may be determined based on at least one of a distance between an optical axis of the off-axis optical system and a dome optical axis of the multi-mode system, the specified material of the wedged window, the at least one specified material of the off-axis optical system, and the specified type of optical system. The off-axis optical system may include a LWIR telescope, a MWIR telescope, a SWIR telescope, a UV telescope, or a visible light telescope. The multi-mode system may also include a second wedged window coupled to the dome frame. The second wedged window may include a second outer curved surface and a second inner curved surface. The second inner curved surface may be tilted at a second specified angle with respect to the second outer curved surface. The second outer curved surface may be configured to receive the signal wavefront for the multi-mode optical device, which may further include a second off-axis optical system. The second inner curved surface may be configured to direct a second refracted wavefront based on the signal wavefront toward the second off-axis optical system. The wedged window may include sapphire, zinc sulfide, zinc selenide, germanium, silicon, calcium fluoride, chalcogenide glasses, nanocrystalline optical ceramics, germanate glass, or calcium aluminate glass. The dome frame may include metal or glass.

In a third embodiment, a multi-mode optical device may include an off-axis optical system and a multi-mode system that includes a wedged window. The wedged window may include an outer curved surface and an inner curved surface. The inner curved surface may be tilted at a specified angle with respect to the outer curved surface. The outer curved surface may be configured to receive a signal wavefront for the multi-mode optical device. The inner curved surface may be configured to direct a refracted wavefront based on the signal wavefront toward the off-axis optical system.

Any single one or any combination of the following features may be used with the third embodiment. The wedged window may include a specified material, the off-axis optical system may include at least one specified material, and the off-axis optical system may include a specified type of optical system. The specified angle may be determined based on at least one of a distance between an optical axis of the off-axis optical system and a dome optical axis of the multi-mode system, the specified material of the wedged window, the at least one specified material of the off-axis optical system, and the specified type of optical system. The off-axis optical system may include a LWIR telescope, a MWIR telescope, a SWIR telescope, a UV telescope, or a visible light telescope. The multi-mode optical device may also include a second off-axis optical system. The multi-mode system may also include a second wedged window. The second wedged window may include a second outer curved surface and a second inner curved surface. The second inner curved surface may be tilted at a second specified angle with respect to the second outer curved surface. The second outer curved surface may be configured to receive the signal wavefront for the multi-mode optical device. The second inner curved surface may be configured to direct a second refracted wavefront based on the signal wavefront toward the second off-axis optical system. The multi-mode optical device may also include an on-axis optical system. The multi-mode system may also include a dome frame. The dome frame may include metal or glass, and the wedged window may include sapphire, zinc sulfide, zinc selenide, germanium, silicon, calcium fluoride, chalcogenide glasses, nanocrystalline optical ceramics, germanate glass, or calcium aluminate glass.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A and 1B illustrate examples of a multi-mode optical device including a wedged window according to this disclosure;

FIG. 2 illustrates an example of a portion of the multi-mode optical device of FIG. 1A or 1B according to this disclosure;

FIG. 3 illustrates an example of the multi-mode system of FIG. 1A, 1B or 2 according to this disclosure; and

FIGS. 4A and 4B illustrate a set of graphs depicting examples of diffraction modulation transfer functions related to the use of the multi-mode optical device of FIG. 1A, 1B or 2 according to this disclosure.

### DETAILED DESCRIPTION

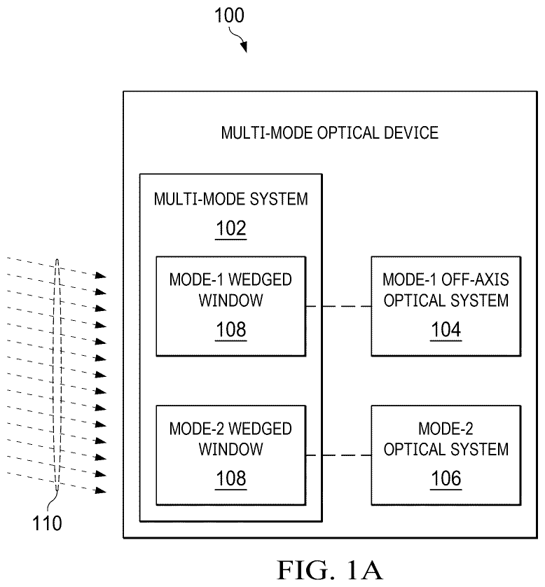

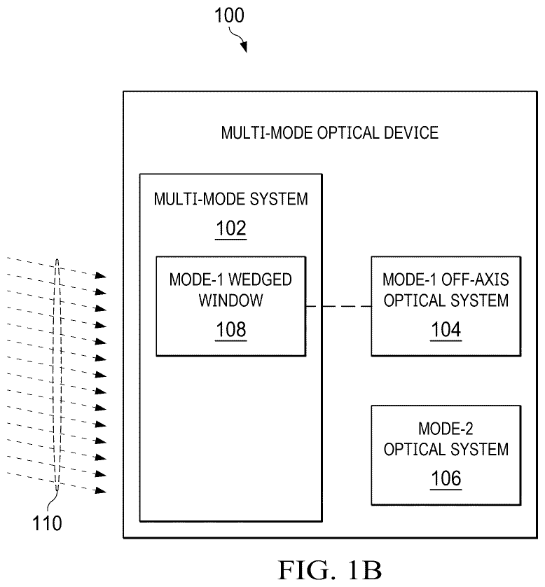

FIGS. 1A through 4B, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, conventional optical devices that include multiple optical systems receiving image information through a single dome may include optical systems that are aligned off-axis. In addition, due to space constraints, multi-mode systems that include two or more optical systems may position each optical system off-axis. Any optical system that is aligned off-axis in such a device receives image information through an oblique section of the dome, which can introduce severe aberrations into images formed by the optical system.

As a particular example of this, seeker optics in a seeker head are traditionally designed to look through an axially-symmetric section of the seeker dome to minimize aberrations. This approach primarily introduces spherical aberration, the dominant aberration encountered on-axis. This spherical aberration can be effectively mitigated through several design techniques, including the use of aspheric components and intentional defocus. However, this conventional design methodology imposes significant constraints. For example, it necessitates that the optics be centrally located within the seeker head, thereby potentially suboptimally utilizing seeker space for given specific requirements. This suboptimal space utilization presents a significant design challenge, especially within the confined space of the seeker head where optical performance may be compromised and where cost and complexity are increased to enable a multi-mode system. Furthermore, this centralization of optics limits the potential for co-aligning multiple systems, which may be useful or important for applications involving bore-sighted alignment of various instruments to operate in tandem. In order to have enough space for multiple systems, the optics may share the same optical path or may be placed off-axis within the seeker head.

Unfortunately, when optics are aligned off-axis, those optics look through an oblique section of the dome, which introduces aberrations like astigmatism, coma, and other higher-order aberrations. Traditional optical designs often do not have enough degrees of freedom to correct these errors, forcing designers to use non-traditional and often suboptimal solutions. For example, instead of using a standard spherical dome, one solution uses a flat window to prevent optical aberrations arising from a spherical dome shape. However, while implementing this type of flat surface allows for easier aberration correction, it also results in an optical device with extremely poor aerodynamics. Thus, for applications in which aerodynamics are a concern, such as with a seeker head, this solution has a highly negative impact on the range and speed of the optical device, aerothermal heating of the optical device in flight, and motor size required to propel the optical device to achieve the desired range.

As another example of this, some conventional optical devices include an arch corrector to provide optical correction of the aberrations introduced by a spherical dome. However, these arch correctors have non-symmetric free-form surfaces on both sides which requires current state of the art fabrication and metrology tools, thus making these correctors difficult and expensive to fabricate and test. The inclusion of another optical element also takes up additional space in the optical device, which is typically quite limited. Also, the design of the optical device itself is more complex because of the introduction of an additional component that needs to be lined up precisely in order for the optical device to provide a clear image. In addition to these limitations, using an arch corrector can result in longer overall length, higher mass, and increased mounting and mechanical complexity for the optical device.

This disclosure provides a wedged window for a multi-mode system. As described in more detail below, the wedged window includes an outer curved surface and an inner curved surface. The inner curved surface can be tilted at a specified angle with respect to the outer curved surface. The outer curved surface can be configured to receive a signal wavefront for a multi-mode optical device that includes the multi-mode system and an off-axis optical system. The inner curved surface can be configured to direct a refracted wavefront based on the signal wavefront toward the off-axis optical system. Thus, instead of avoiding a variable thickness in the dome as is typically done in conventional optical domes in order to avoid the introduction of optical aberrations, the disclosed wedged window for the multi-mode system is intentionally designed with a variable thickness to minimize optical aberrations for the off-axis optical system. In addition, a multi-mode system that includes the wedged window can be designed to remain aerodynamic while also providing superior optical performance in an off-axis optical system. In addition, this can be accomplished without the need for an additional optical element, such as a complex arch corrector, resulting in an efficient, compact, low-cost, and low-drag optical device.

FIGS. 1A and 1B illustrate examples of a multi-mode optical device 100 according to this disclosure. The embodiments of the multi-mode optical device 100 shown in FIGS. 1A and 1B are for illustration only. Other embodiments of the multi-mode optical device 100 may be used without departing from the scope of this disclosure.

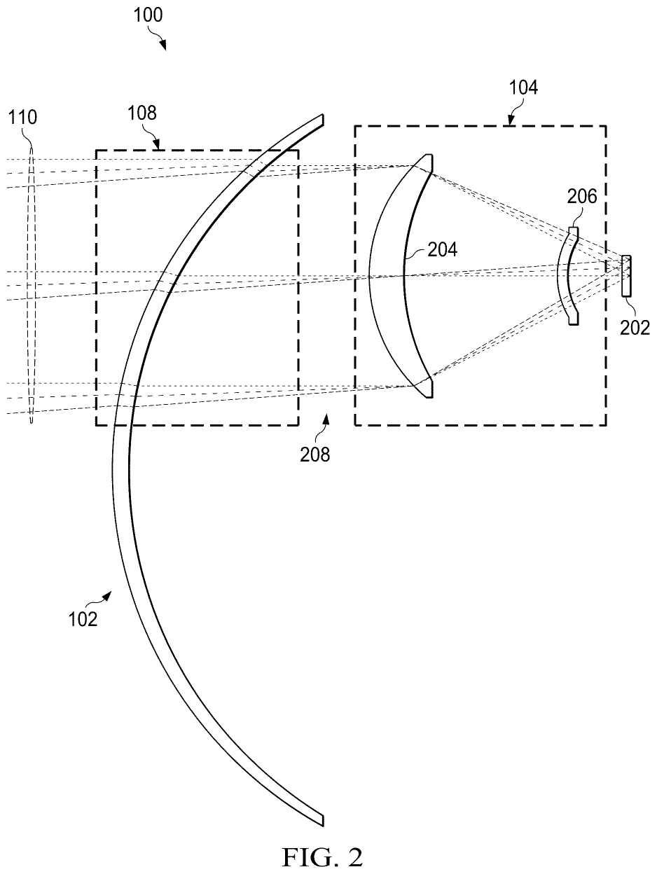

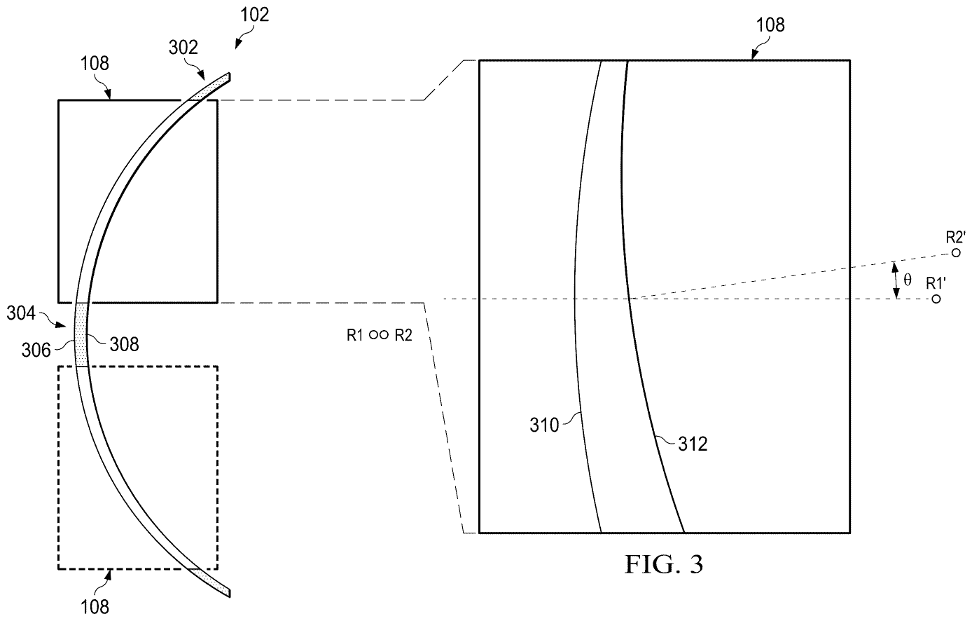

According to embodiments of this disclosure, the multi-mode optical device 100 includes a multi-mode system 102, a mode-1 off-axis optical system 104, and a mode-2 optical system 106. Thus, the multi-mode optical device 100 is configured to operate in at least two different modes, each of which involves a corresponding optical system 104 or 106. As a particular example, in some embodiments, the mode-1 off-axis optical system 104 may be configured to process long-wave infrared (LWIR) wavelengths for a first mode of operation, and the mode-2 optical system 106 may be configured to process mid-wave infrared (MWIR) wavelengths for a second mode of operation. However, it will be understood that each of the optical systems 104 and 106 may be configured to process any suitable band of electromagnetic waves. As illustrated in FIGS. 2 and 3, for some embodiments, the multi-mode system 102 can include a dome with a spherical shape that includes a dome optical axis along a radial line from a center of the dome toward a center for the spherical shape. The mode-1 off-axis optical system 104 is not aligned with this dome optical axis. The mode-2 optical system 106 may either include an off-axis optical system that is not aligned with the dome optical axis (corresponding to FIG. 1A) or an on-axis optical system that is substantially aligned with the dome optical axis (corresponding to FIG. 1B).

The multi-mode system 102 includes a mode-1 wedged window 108 corresponding to the mode-1 off-axis optical system 104. For embodiments in which the mode-2 optical system 106 is an off-axis optical system, as illustrated in FIG. 1A, the multi-mode system 102 also includes a mode-2 wedged window 108 corresponding to the mode-2 optical system 106. However, for embodiments in which the mode-2 optical system 106 is an on-axis optical system, as illustrated in FIG. 1B, the multi-mode system 102 may not include a mode-2 wedged window 108 corresponding to the mode-2 optical system 106. Thus, a wedged window 108 may be included for each off-axis optical system 104 (or 104 and 106) but may not be included for an on-axis mode-2 optical system 106.

Each wedged window 108 may include any suitable material that is substantially transparent to a band of electromagnetic waves to be processed by the corresponding off-axis optical system 104 (or 104 and 106). For example, each wedged window 108 may include sapphire, zinc sulfide, zinc selenide, germanium, silicon, calcium fluoride, chalcogenide glasses, nanocrystalline optical ceramics, germanate glass, calcium aluminate glass, or any other suitable optical material. In some embodiments, each wedged window 108 may be formed by 5-axis diamond turning or other suitable fabrication technique that allows for formation of the wedged window 108 with a variable thickness.

The multi-mode optical device 100 can be configured to operate in at least a first mode via the mode-1 off-axis optical system 104 and/or a second mode via the mode-2 optical system 106. The mode-1 off-axis optical system 104 can be substantially aligned with the mode-1 wedged window 108. In the embodiment illustrated in FIG. 1A including the optional mode-2 wedged window 108, the mode-2 optical system 106 can be an off-axis optical system. For this embodiment, the mode-2 optical system 106 can be substantially aligned with the mode-2 wedged window 108. For the embodiment illustrated in FIG. 1B in which the optional mode-2 wedged window 108 is not included, the multi-mode system102 can include a dome, and the mode-2 optical system 106 can be an on-axis optical system that is substantially aligned with the dome optical axis of the dome.

In some embodiments, the multi-mode optical device 100 may include a seeker head for a missile, a surveillance device, a reconnaissance device, or any other suitable optical device that is configured to receive and process a signal wavefront 110. The optical systems 104 and 106 may each include a LWIR telescope, a MWIR telescope, a short-wave infrared (SWIR) telescope, an ultraviolet (UV) telescope, a visible light telescope, or other suitable optical system. The signal wavefront 110 may include any electromagnetic waves, such as waves in the LWIR band, the MWIR band, the SWIR band, the UV band, the visible light spectrum, and the like. In some embodiments, the optical systems 104 and 106 may include different types of optical systems.

Although FIG. 1 illustrates one example of a multi-mode optical device 100, various changes may be made to FIG. 1. For instance, the multi-mode optical device 100 may include additional components not shown in FIG. 1. As particular examples, in addition to a mode-1 off-axis optical system 104 and a mode-2 optical system 106 that is off-axis (along with their corresponding wedged windows 108 in the multi-mode system 102), the multi-mode optical device 100 may include a mode-3 on-axis optical system without a corresponding wedged window 108. In addition, note that the view shown in FIG. 1 is not to scale.

FIG. 2 illustrates an example of a portion of the multi-mode optical device 100 according to this disclosure. The embodiment of the multi-mode optical device 100 shown in FIG. 2 is for illustration only. Other embodiments of the multi-mode optical device 100 may be used without departing from the scope of this disclosure.

According to embodiments of this disclosure, the multi-mode optical device 100 includes the multi-mode system 102, the mode-1 off-axis optical system 104, the wedged window 108 within the multi-mode system 102 corresponding to the mode-1 off-axis optical system 104, and an image device 202. It will be understood that the multi-mode optical device 100 may include at least one more optical system 106 (not illustrated in FIG. 2), whether on-or off-axis. In the illustrated embodiment, the mode-1 off-axis optical system 104 includes a first lens 204 and a second lens 206, which together form a telescope. The wedged window 108 can be configured to receive a signal wavefront 110 from outside the multi-mode optical device 100 and to alter the path of at least a portion of the signal wavefront 110 passing through the wedged window 108 to produce a refracted wavefront 208 inside the multi-mode optical device 100 based on the signal wavefront 110. The refracted wavefront 208 can be directed toward the mode-1 off-axis optical system 104 for processing.

The wedged window 108 may be configured such that the refracted wavefront 208 incident on the first lens 204 is similar in quality to a wavefront that would be incident on a first lens of an on-axis optical system (whether included in the multi-mode optical device 100 or not) based on a signal wavefront 110 that had passed through a central portion of the multi-mode system 102 including a dome. In other words, the refracted wavefront 208 can be similar in quality to a signal wavefront that has not passed through a wedged window 108 but through a non-wedged central section of the dome before being incident on an optical system aligned with the dome optical axis. In other cases, the wedged window 108 may be configured such that the refracted wavefront 208 incident on the first lens 204 is similar in quality to a signal wavefront received through a flat window or through a combination of an oblique section of a dome and an arch corrector.

The lenses 204 and 206 of the optical system 104 can be configured to receive the refracted wavefront 208 and to transmit and focus the refracted wavefront 208 towards the image device 202. In some embodiments, the image device 202 may include a focal plane on which an image may be formed by the optical system 104 based on the refracted wavefront 208.

During operation of the multi-mode optical device 100, the signal wavefront 110 may be received through the multi-mode system 102 and provided as a refracted wavefront 208 to the optical systems 104 and 106 for processing. For example, in the illustrated embodiment, a signal wavefront 110 passing through the mode-1 wedged window 108 may be provided as a refracted wavefront 208 to the mode-1 off-axis optical system 104. In addition, for some embodiments, the signal wavefront 110 passing through the optional mode-2 wedged window 108 may be provided as a refracted wavefront 208 to an off-axis mode-2 optical system 106 (not shown in FIG. 2). For other embodiments without the optional mode-2 wedged window 108, the signal wavefront 110 passing through a central portion of a dome of the multi-mode system 102 may be provided to an on-axis mode-2 optical system 106 (not shown in FIG. 2). As described in more detail below, each included wedged window 108 can be configured with dimensions that allow the signal wavefront 110 to be minimally affected while passing through the wedged window 108 as compared to a signal wavefront that passes through an oblique section of a conventional dome.

In some embodiments, the mode-1 wedge window 108 and the mode-1 off-axis optical system 104 may be mounted to a common assembly such that the mode-1 wedged window 108 remains in a constant location with respect to the mode-1 off-axis optical system 104 regardless of any motion of the multi-mode optical device 100. In these embodiments, the mode-1 wedged window 108 may be paired with a predetermined tilt of the mode-1 off-axis optical system 104. In this way, the mode-1 wedged window 108 may be configured to roll and nod with the mode-1 off-axis optical system 104, resulting in a consistent clear aperture for the mode-1 off-axis optical system 104 across substantially all possible orientations. In addition, positioning sensitivity for the multi-mode system 102 with respect to the mode-1 off-axis optical system 104 may be decreased as compared to an optical device that includes an arch corrector between a dome and an optical system. As a result, the multi-mode optical device 100 may be fabricated more easily, as well as in a more cost-efficient manner.

Although FIG. 2 illustrates one example of a portion of the multi-mode optical device of FIG. 1, various changes may be made to FIG. 2. For instance, the multi-mode optical device 100 may include additional components not shown in FIG. 2. As particular examples, the multi-mode optical device 100 may include at least one additional optical system 106, which also includes a corresponding image device 202. Also, if the additional optical system 106 is an off-axis optical system, the multi-mode optical device 100 may include an additional wedged window 108 within the multi-mode system 102 corresponding to the optical system 106. In addition, note that the view shown in FIG. 2 is not to scale.

FIG. 3 illustrates an example of the multi-mode system 102 according to this disclosure. The embodiment of the multi-mode system 102 shown in FIG. 3 is for illustration only. Other embodiments of the multi-mode system 102 may be used without departing from the scope of this disclosure.

According to embodiments of this disclosure, the multi-mode system 102 may include a dome, which may include a dome frame 302 and at least one wedged window 108 coupled to the dome frame 302. As described above in connection with FIGS. 1A, 1B and 2, the multi-mode system 102 may include an optional second wedged window 108 coupled to the dome frame 302 for embodiments in which the mode-2 optical system 106 includes an off-axis optical system.

The dome frame 302 may be configured to secure the wedged window or windows 108 within the multi-mode system 102. The dome frame 302 may include metal, glass and/or any other material suitable for securing each wedged window 108 in a particular position. For a multi-mode optical device 100 that includes an on-axis optical system as either the mode-2 optical system 106, as described above in connection with FIGS. 1B and 2, or as a mode-3 optical system, the dome frame 302 may include glass for a central portion 304 of the dome frame 302 to allow the signal wavefront 110 to pass through and be received at the on-axis optical system. In some embodiments, the multi-mode system 102 may be formed by coupling the wedged window 108 to the dome frame 302 with an adhesive, with a coupling component, or in any other suitable manner.

As illustrated in FIG. 3, the dome frame 302 of the multi-mode system 102 may be configured to include an outer curved surface 306 and an inner curved surface 308 such that a radius of curvature from a central point of the dome to the center of curvature R1 for the outer curved surface 306 is aligned with a radius of curvature from the central point of the dome to the center of curvature R2 for the inner curved surface 308. Note that the dome optical axis of the dome can be defined by a line that includes these two points R1 and R2. In contrast to this, the wedged window 108 can include an outer curved surface 310 and an inner curved surface 312 such that a radius of curvature from a central point of the outer curved surface 310 to its center of curvature R1′ is not aligned with a radius of curvature from a central point of the inner curved surface 312 to its center of curvature R2′. Instead, the inner curved surface 312 is tilted at a specified angle θ with respect to the outer curved surface 310. Note that each of the surfaces 306, 308, 310 and 312 can be spherical, aspheric, or of some other surface profile in accordance with the particular application in which the multi-mode optical device 100 is implemented.

The signal wavefront 110 may undergo refraction upon entering the wedged window 108 at the outer curved surface 310 and upon exiting the wedged window 108 at the inner curved surface 312. Thus, the outer curved surface 310 may be configured to receive the signal wavefront 110 for the multi-mode optical device 100, and the inner curved surface 312 may be configured to direct the refracted wavefront 208 toward the mode-1 off-axis optical system 104. While each of the curved surfaces 310 and 312 can be substantially spherical in shape, due to the misalignment between their radii of curvature resulting from the tilt of the inner curved surface 312, the wedged window 108 provides a non-concentric dome section with a variable thickness as part of the multi-mode system 102. The difference in thickness between a first end of the wedged window 108 and a second end of the wedged window 108 is based on the specified angle θ. This specified angle θ and the resulting thickness of the wedged window 108 may be designed such that the refracted wavefront 208 is minimally affected by bending of the signal wavefront 110 at the curved surfaces 310 and 312 of the wedged window 108.

In some embodiments, the dimensions of the wedged window 108 may be determined based on a distance between the corresponding off-axis optical system 104 or 106 and the dome optical axis. The dimensions of the wedged window 108 may also or alternatively be determined based on the specific materials of the wedged window 108 and/or the corresponding optical system 104 or 106 (such as the lenses 204 and 206). The dimensions of the wedged window 108 may also or alternatively be determined based on a type of the corresponding optical system 104 or 106, such as whether the optical system 104 or 106 includes a LWIR telescope, a MWIR telescope, a SWIR telescope, a UV light telescope, a visible light telescope, etc.

By designing the wedged window 108 with a variable thickness based on these or other considerations, the corresponding optical system 104 or 106 is allowed to receive a refracted wavefront 208 produced based on a signal wavefront 110 that has been received through an oblique angle of the dome with minimal aberration. Thus, the variable thickness of the wedged window 108 results in a more uniform effective thickness across the aperture along the optical axis of the corresponding optical system 104 or 106, minimizing aberration that is typically inherent in a signal wavefront 110 received through an oblique angle. In addition, the outer curved surface 306 of the dome can remain substantially spherical, allowing the multi-mode optical device 100 to remain aerodynamic, while also providing optical performance in an off-axis optical system 104 or 106 that is similar to expected performance for an on-axis optical system. This can be accomplished without the need for an additional optical element, such as a complex arch corrector, resulting in an efficient, compact, low-cost, low-drag multi-mode optical device 100.

Although FIG. 3 illustrates one example of a multi-mode system 102 including a wedged window 108, various changes may be made to FIG. 3. For instance, the multi-mode system 102 may include additional components not shown in FIG. 3. In addition, note that the view shown in FIG. 3 is not to scale.

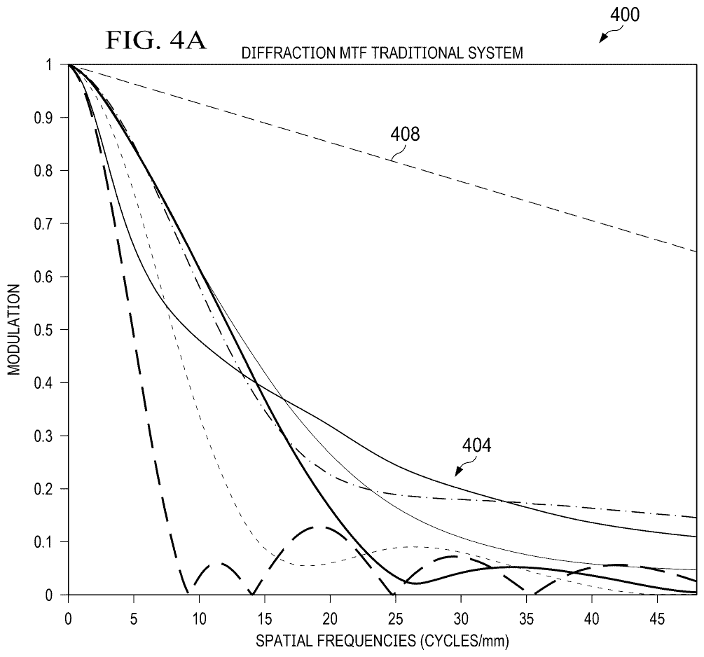

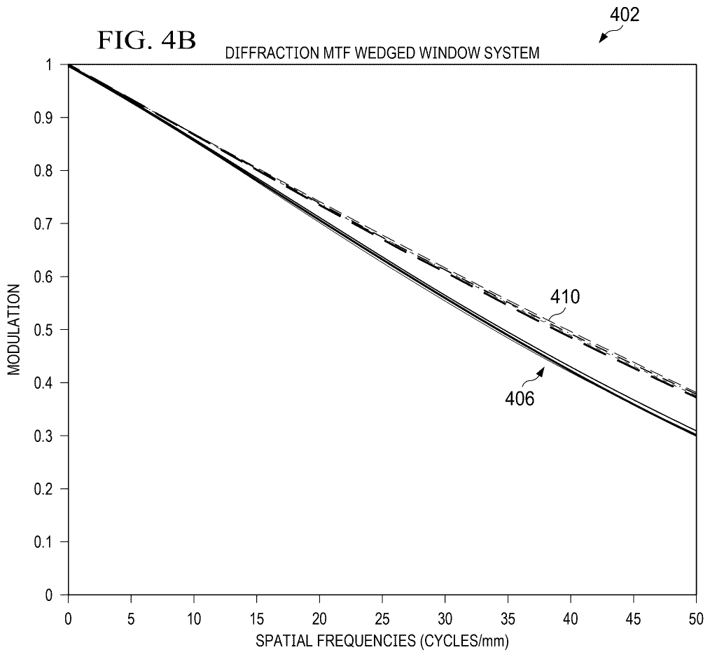

FIGS. 4A and 4B illustrate a set of graphs 400 and 402 depicting examples of diffraction modulation transfer functions (MTFs) 404 and 406 related to the use of the multi-mode optical device 100 according to this disclosure. The diffraction MTFs 404 and 406 shown in FIGS. 4A and 4B are for illustration only. Different diffraction MTFs may occur without departing from the scope of this disclosure.

According to embodiments of this disclosure, the graph 400 of FIG. 4A includes an ideal line 408 at which image clarity is greatest. Similarly, the graph 402 of FIG. 4B includes an ideal line 410 at which image clarity is greatest. Along these ideal lines 408 and 410, the contrast provided by the refracted wavefront 208 allows for maximum ability to distinguish between image features having a full range of spatial frequencies.

The graph 400 of FIG. 4A illustrates the diffraction MTFs 404 for an optical device in which a refracted wavefront is received at an off-axis optical system without the inclusion of a wedged window 108 in a dome or other multi-mode system. As these diffraction MTFs 404 quickly fall away from the ideal line 408, images generated without the wedged window 108 will have extremely poor clarity. On the other hand, the graph 402 of FIG. 4B illustrates the diffraction MTFs 406 for the multi-mode optical device 100 in which the refracted wavefront 208 is received at the mode-1 off-axis optical system 104 (and the mode-2 optical system 106 for embodiments in which this is an off-axis optical system) after passing through the corresponding wedged window 108 in the multi-mode system 102. As these diffraction MTFs 406 closely track with the ideal line 410, images generated with the wedged window 108 included in the multi-mode system 102 will have superior clarity as compared to those generated without a wedged window 108.

Thus, including the wedged window 108 as part of the multi-mode system 102 for the mode-1 off-axis optical system 104 (and the mode-2 optical system 106 for embodiments in which this is an off-axis optical system) results in greatly improved optical performance for the multi-mode optical device 100. This can also be accomplished while maintaining the ability of the multi-mode optical device 100 to remain aerodynamic and while keeping the costs and difficulty of fabrication minimized.

Although FIGS. 4A and 4B illustrate examples of diffraction MTFs 404 and 406 related to the use of a multi-mode optical device 100, various changes may be made to FIGS. 4A and 4B. For instance, the diffraction MTFs will vary with the specific physical characteristics of the actual multi-mode optical device 100. It will be understood that diffraction MTFs similar to those shown in the graph 400 can result from the use of a conventional dome with an off-axis optical system, and diffraction MTFs similar to those shown in the graph 402 can result when the multi-mode system 102 including the wedged window 108 is implemented.

It may be advantageous to set forth definitions of certain words and phrases used throughout this patent document. The term “about” (when used with a numerical value) indicates that the numerical value may vary by up to ±10%. The terms “include” and “include,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 114(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 114(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A wedged window for a multi-mode system including:
an outer curved surface; and
an inner curved surface;
wherein the inner curved surface is tilted at a specified angle with respect to the outer curved surface;
wherein the outer curved surface is configured to receive a signal wavefront for a multi-mode optical device including the multi-mode system and an off-axis optical system; and
wherein the inner curved surface is configured to direct a refracted wavefront based on the signal wavefront toward the off-axis optical system.

2. The wedged window of claim 1, wherein the outer curved surface is substantially aligned with an optical axis of the off-axis optical system.

3. The wedged window of claim 1, wherein the specified angle is determined based on a distance between an optical axis of the off-axis optical system and a dome optical axis of the multi-mode system.

4. The wedged window of claim 1, wherein:
the wedged window includes a specified material; and
the specified angle is determined based on the specified material.

5. The wedged window of claim 1, wherein:
the off-axis optical system includes at least one specified material; and
the specified angle is determined based on the at least one specified material.

6. The wedged window of claim 1, wherein:
the off-axis optical system includes a specified type of optical system; and
the specified angle is determined based on the specified type of optical system.

7. The wedged window of claim 1, wherein the off-axis optical system includes a long-wave infrared (LWIR) telescope, a mid-wave infrared (MWIR) telescope, a short-wave infrared (SWIR) telescope, an ultraviolet (UV) telescope, or a visible light telescope.

8. The wedged window of claim 1, wherein the wedged window includes sapphire, zinc sulfide, zinc selenide, germanium, silicon, calcium fluoride, chalcogenide glasses, nanocrystalline optical ceramics, germanate glass, or calcium aluminate glass.

9. A multi-mode system including:
a dome frame; and
a wedged window coupled to the dome frame;
wherein the wedged window includes an outer curved surface and an inner curved surface;
wherein the inner curved surface is tilted at a specified angle with respect to the outer curved surface;
wherein the outer curved surface is configured to receive a signal wavefront for a multi-mode optical device including the multi-mode system and an off-axis optical system; and
wherein the inner curved surface is configured to direct a refracted wavefront based on the signal wavefront toward the off-axis optical system.

10. The multi-mode system of claim 9, wherein:
the wedged window includes a specified material;
the off-axis optical system includes at least one specified material;
the off-axis optical system includes a specified type of optical system; and
the specified angle is determined based on at least one of:
a distance between an optical axis of the off-axis optical system and a dome optical axis of the multi-mode system,
the specified material of the wedged window,
the at least one specified material of the off-axis optical system, and
the specified type of optical system.

11. The multi-mode system of claim 9, wherein the off-axis optical system includes a LWIR telescope, a MWIR telescope, a SWIR telescope, a UV telescope, or a visible light telescope.

12. The multi-mode system of claim 9, further including a second wedged window coupled to the dome frame;
wherein the second wedged window includes a second outer curved surface and a second inner curved surface;
wherein the second inner curved surface is tilted at a second specified angle with respect to the second outer curved surface;
wherein the second outer curved surface is configured to receive the signal wavefront for the multi-mode optical device, the multi-mode optical device further including a second off-axis optical system; and
wherein the second inner curved surface is configured to direct a second refracted wavefront based on the signal wavefront toward the second off-axis optical system.

13. The multi-mode system of claim 9, wherein the wedged window includes sapphire, zinc sulfide, zinc selenide, germanium, silicon, calcium fluoride, chalcogenide glasses, nanocrystalline optical ceramics, germanate glass, or calcium aluminate glass.

14. The multi-mode system of claim 9, wherein the dome frame includes metal or glass.

15. A multi-mode optical device including:
an off-axis optical system; and
a multi-mode system including a wedged window;
wherein the wedged window includes an outer curved surface and an inner curved surface;
wherein the inner curved surface is tilted at a specified angle with respect to the outer curved surface;
wherein the outer curved surface is configured to receive a signal wavefront for the multi-mode optical device; and
wherein the inner curved surface is configured to direct a refracted wavefront based on the signal wavefront toward the off-axis optical system.

16. The multi-mode optical device of claim 15, wherein:
the wedged window includes a specified material;
the off-axis optical system includes at least one specified material;
the off-axis optical system includes a specified type of optical system; and
the specified angle is determined based on at least one of:
a distance between an optical axis of the off-axis optical system and a dome optical axis of the multi-mode system,
the specified material of the wedged window,
the at least one specified material of the off-axis optical system, and
the specified type of optical system.

17. The multi-mode optical device of claim 15, wherein the off-axis optical system includes a LWIR telescope, a MWIR telescope, a SWIR telescope, a UV telescope, or a visible light telescope.

18. The multi-mode optical device of claim 15, further including a second off-axis optical system:
wherein the multi-mode system further includes a second wedged window;
wherein the second wedged window includes a second outer curved surface and a second inner curved surface;
wherein the second inner curved surface is tilted at a second specified angle with respect to the second outer curved surface;
wherein the second outer curved surface is configured to receive the signal wavefront for the multi-mode optical device; and
wherein the second inner curved surface is configured to direct a second refracted wavefront based on the signal wavefront toward the second off-axis optical system.

19. The multi-mode optical device of claim 15, further including an on-axis optical system.

20. The multi-mode optical device of claim 15, wherein:
the multi-mode system further includes a dome frame;
the dome frame includes metal or glass; and
the wedged window includes sapphire, zinc sulfide, zinc selenide, germanium, silicon, calcium fluoride, chalcogenide glasses, nanocrystalline optical ceramics, germanate glass, or calcium aluminate glass.
